(19) United States
(12) Patent Application Publication
(10) Pub. No.: US 2012/0079293 A1
(43) Pub. Date: Mar. 29, 2012

(54) UPGRADE KIT AND POWER MANAGEMENT DEVICE FOR AN UPGRADE KIT

(76) Inventors: Jinbo Xu, Beijing (CN); Ming Liu, Beijing (CN)

(21) Appl. No.: 13/241,618

(22) Filed: Sep. 23, 2011

(30) Foreign Application Priority Data
Sep. 25, 2010 (CN) 201010294397.1

(51) Int. Cl. G06F 1/26

(52) U.S. Cl. 713/300

(57) ABSTRACT

A power management device for an upgrade kit for upgrading a target system to a digital system is provided. The power management device includes a sensor configured to sense a power status of the target system, and a power distribution unit configured to power on or off all subsystems of the upgrade kit according to the power status.

### CROSS REFERENCE TO RELATED APPLICATIONS

This application claims the benefit of Chinese Patent Application No. 201010294397.1 filed Sep. 25, 2010, which is hereby incorporated by reference in its entirety.

### BACKGROUND OF THE INVENTION

The embodiments described herein relate to the X-ray machine field, and particularly relates to a power management device for an upgrade kit and to an upgrade kit.

As is known X-ray products mostly were analog systems in the past. In order to upgrade these analog systems to digital systems, X-ray products manufacturers provide some solutions, that is, upgrade kit. Connecting upgrade kits to original analog systems can upgrade original analog systems to digital systems, with no need to discard original analog systems, such that the costs are greatly saved.

In addition, because these upgrade kits are powered on and off independently from target systems (analog systems to be upgraded), customers manually power on/off both target systems and upgrade kits. Only when the target system and the upgrade kit are both powered on normally, the digital system obtained from upgrading can work normally.

However, in the actual application process, after a customer powered on the target system, the customer usually forgot to power on the upgrade kit, and did not find that they forgot to power on the upgrade kit until no digital image is obtained after exposure, causing patients to be imposed with too much X-ray dose, thus the safety is bad. Moreover, a great amount of time is wasted.

### SUMMARY OF THE INVENTION

The embodiments described herein provide a safe power management device for an upgrade kit and an upgrade kit, which can automatically power on or off all subsystems of the upgrade kit according to the power status of the target system.

In one aspect, the power management device for an upgrade kit (the upgrade kit is used for upgrading a target system to a digital system) includes a sensor for sensing the power status of the target system and a power distribution unit for powering on or off all the subsystems of the upgrade kit according to the power status.

Preferably, the power management device for an upgrade kit includes a controller for receiving a signal representing the power status from the sensor.

The controller preferably includes a receiver for receiving a signal from the sensor, a microcontroller for receiving a signal from the receiver, and a relay controlled by the microcontroller.

The power distribution unit preferably includes a transformer, one or more relays, and one or more AC-DC converters connected with the transformer.

In addition, the sensor can acquire the power status of the target system by a cable intervening into the target system.

In addition, if the signal received by the controller represents that the target system is in power-off status, the controller commands PC subsystem to exit individual systems running thereon.

The controller commands the power distribution unit to power off all the subsystems after having received the signal representing power-off for a period of time.

The controller can be in communication with the PC subsystem via a RS232 standard interface.

In another aspect, an upgrade kit for upgrading the target system to a digital system includes a power management device. The power management device includes a sensor for sensing the power status of the target system and a power distribution unit for powering on or off all the subsystems of the upgrade kit according to the power status.

In addition, the power management device further includes a controller for receiving a signal representing the power status from the sensor.

The controller includes a receiver for receiving a signal from the sensor, a microcontroller for receiving a signal from the receiver, and a relay controlled by the microcontroller.

The power distribution unit includes a transformer, one or more relays, and one or more AC-DC converters connected with the transformer.

The sensor can acquire the power status of the target system by a cable intervening into the target system.

Preferably, if the signal received by the controller represents that the target system is in power-off status, the controller commands PC subsystem to exit individual systems running thereon.

The controller commands the power distribution unit to power off all the subsystems after having received the signal representing power off for a period of time.

The controller may be in communication with the PC subsystem via a RS232 standard interface.

Compared to known upgrade systems, the power management system for an upgrade kit and the upgrade kit have the following advantages. Because the embodiments described herein employ a power distribution unit, which can power on or off all the subsystems of the upgrade unit according to the power status of the target system, to avoid X-ray overdose to a patient owing to forgetting to power on the subsystem of the upgrade kit. Thus, the safety for the patient is enhanced.

### DESCRIPTION OF THE DRAWINGS

By reference to the figures and in accordance with the following depiction which are given only as examples, the present invention will be understood more clearly, in the figures:

FIG. 1 shows the diagram of the principle a power management device for an upgrade kit;

FIG. 2 shows a schematic diagram of the controller in FIG. 1;

FIG. 3 shows a schematic diagram of the power distribution unit in FIG. 1.

### DETAILED DESCRIPTION OF THE INVENTION

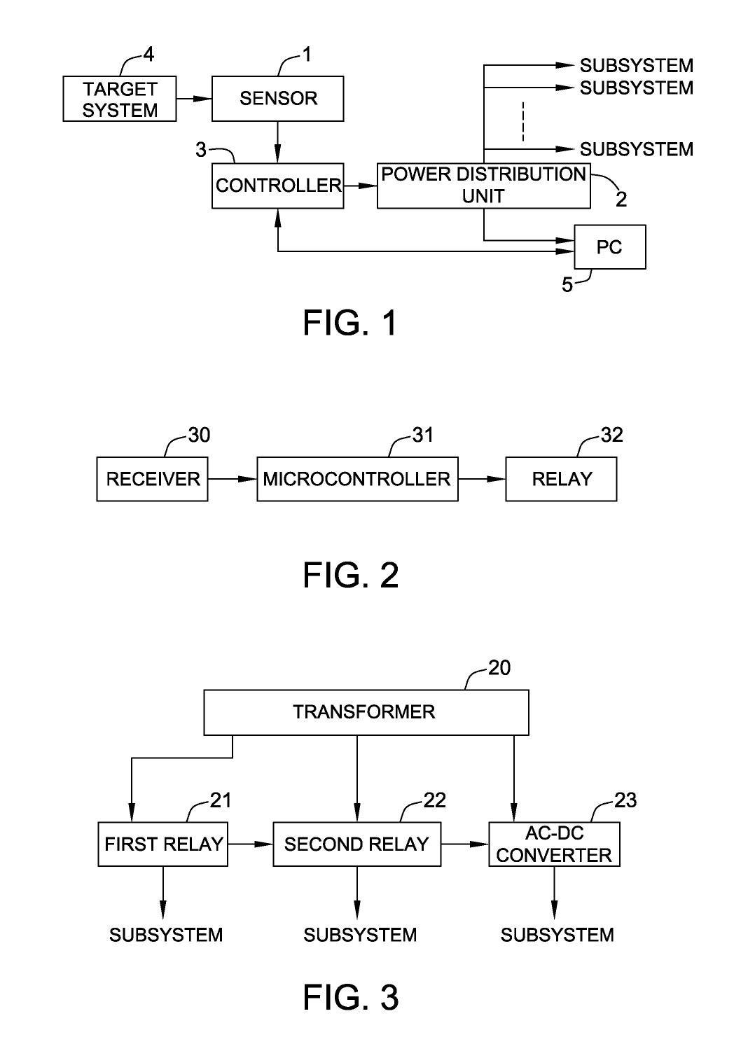

As shown in FIG. 1, the figure shows a diagram of the principle of a power management device for an upgrade kit. The upgrade kit is used for upgrading the target system to a digital system. The power management device for an upgrade kit includes a sensor 1 for sensing the power status of the target system 4 and a power distribution unit 2 for powering on or off all the subsystems of the upgrade kit according to the power status.

As seen from the above, the sensor 1 is used for sensing the power status of the target system 4. If the target system is in power-on status, the power distribution unit 2 powers on all the subsystems of the upgrade kit. If the target system is in power-off status, the power distribution unit 2 powers off all the subsystems of the upgrade kit. Thus, the subsystems can be powered on or off automatically according to the power status of the target system. As such, the subsystems are not powered on or off manually by doctors, thereby avoiding a dose of radiation to a patient when only the target system is powered on but the subsystems are not powered on. Therefore, the safety for the patient is improved and time is saved.

Again, as shown in FIG. 1, the power management device further includes a controller 3 for receiving a signal representing the power status from the sensor 1. The controller 3 may receive a signal from the sensor 1 and control the power distribution unit 2 to work based on the signal.

As shown in FIG. 2, the controller 3 includes a receiver 30 for receiving a signal from the sensor 1, a microcontroller 31 for receiving a signal from the receiver 30, and a relay 32 controlled by the microcontroller 31.

The receiver 30 converts a signal received from the sensor 1 to a high/low level signal that can be identified by the microcontroller 31. When the microcontroller 31 receives a low level signal, the microcontroller 31 controls the relay 32 to close such that the power distribution unit 2 obtains an instruction of starting to supply power to each subsystem. When the microcontroller 31 receives a high level signal, the microcontroller 31 controls the relay 32 to break such that the power distribution unit 2 obtains an instruction of stopping supplying power to each subsystem.

As shown in FIG. 3, the power distribution unit 2 includes a transformer 20, a first relay 21, a second relay 22, and an AC-DC converter 23. Although two relays 21 and 22 are shown in the FIG. 3, yet the power distribution unit 2 is not limited to two relays, and may include only one relay or more than two relays. For the AC-DC converter 23, only one AC-DC converter 23 is shown in the FIG. 3, but the AC-DC converter is not limited to including only one AC-DC converter, rather more than one AC-DC converter may be possible.

The transformer 20 of the power distribution unit 2 receives exterior voltage, and then converts the exterior voltage to alternating current and transmits the alternating current to individual relays 20, 21 and the AC-DC converter 23 connected thereto. When the power distribution unit 2 receives a power-on or power-off command from the controller 3, the power distribution unit 2 controls individual relays 20, 21 and the AC-DC converter 23 to supply power to individual subsystems or to power off individual subsystems.

The sensor 1 can acquire the power status of the target system 4 by a cable (not shown) intervening into the target system.

As is known, for some subsystems, for example, directly powering a detector off will not cause damage to the detector. While for some other subsystems, for example, a PC 5, the normal operation is firstly shutting down individual systems running on the PC 5 and then powering off the PC 5. Thus, in order to prevent powering off the PC 5 directly without shutting down individual systems running on the PC 5, when the signal received by the controller 3 represents that the target system 4 is in power-off status, the controller 3 firstly commands the PC subsystem (i.e. the PC 5) to exit individual systems running thereon. Thereafter, after having received the signal representing power-off from the sensor 1 for a period of time, the controller 3 commands the power distribution unit 2 to power off all the subsystems. As such, the condition of powering off the PC subsystem when each system running on the PC 5 does not exit can be avoided. Thus better protection is provided to the PC subsystem.

The controller 3 may be in communication with the PC 5 via a RS232 standard interface.

Next, the embodiments described herein are described in detail by an example. Please note that this is only an example, and is not for limiting the scope of the present invention.

Assuming that the target system is P500D (an X-ray machine integrated with radiography and photoscope), the sensor 1 adopts a RTE24615, the receiver 30 adopts a MC1489A, the microcontroller 31 adopts an ARM (LPC2468), the replay 32 in the controller 3 adopts a G6B_{—}2114P, the transformer 20 adopts a SRT-10-3-1RC, the first relay 21 adopts a switch K1, the second relay 22 adopts a switch K2, and the AC-DC converter 23 adopts a HWS50-24-ME.

The transformer 20 receives a voltage of 110-230V, in this example. The transformer 20 directly delivers an alternating current of 110V to the PC 5 and the detector via switches K1 and K2, and delivers an alternating current of 110V to the control panel via the AC-DC converter 23.

After the P500D system is powered on, the sensor 1 detects a target system power-on signal and reports it to the receiver 30. The receiver 30 converts the power-on signal to a low level signal and transfers it to the microcontroller 31. The microcontroller 31 controls the relay 32 to close, and thus the power distribution unit 2 receives a power-up instruction. The relays 21 and 22 act to power on individual subsystems.

After the P500D system is powered off, the sensor 1 detects a target system power-off signal and reports it to the receiver 30. The receiver 30 converts the power-off signal to a high level signal and transfers it to the microcontroller 31. The microcontroller 31 firstly notifies the computer to power off via RS232, and after waiting for a period of time, controls the relay 32 to close. Thus, the power distribution unit 2 receives a power-down instruction. The relays 21 and 22 act to power off individual subsystems.

In another aspect an upgrade kit for upgrading the target system to a digital system is provided. The upgrade kit includes a power management device. The power management device includes a sensor 1 for sensing the power status of the target system 4 and a power distribution unit 2 for powering on or off all the subsystems of the upgrade kit according to the power status.

The power management device further includes a controller 3 for receiving a signal representing the power status.

The controller 3 includes a receiver 30 for receiving a signal from the sensor 1, a microcontroller 31 for receiving a signal from the receiver 30, and a relay 32 controlled by the microcontroller 31.

In addition, the power distribution unit 2 includes a transformer 20, one or more relays 21, 22, and one or more AC-DC converters 23 connected with the transformer 20.

Further, the sensor 1 can acquire the power status of the target system 4 by a cable (not shown) intervening into the target system.

If the signal received by the controller 3 represents that the target system 4 is in power-off status, the controller 3 commands the PC subsystem 5 to exit individual systems running thereon.

In addition, the controller 3 may command the power distribution unit 2 to power off all the subsystems after having received the signal representing power-off for a period of time.

The controller may be in communication with the PC 5 via a RS232 standard interface.

Because the power management device included in the upgrade kit is similar to the power management device for an upgrade kit, the power management device is not described in further detail here.

In sum, since the embodiments described herein include a power distribution unit 2 that can power on or off all the subsystems of the upgrade unit according to the power status of the target system 4, the embodiments described herein may avoid X-ray overdose to a patient owing to forgetting to power on the subsystem of the upgrade kit, thus the safety for the patient is enhanced.

Although the embodiment of the present invention has been described in the text above in combination with the figures, those skilled in the art may make various variation, modification and equivalence to the present invention without departing from the spirit and scope of the present invention, these variation, modification and equivalence are all intended to fall within the spirit and scope defined by the appended claims.

1. A power management device for an upgrade kit for upgrading a target system to a digital system, the power management device comprises:
a sensor configured to sense a power status of the target system; and
a power distribution unit configured to power on or off all subsystems of the upgrade kit according to the power status.

2. A power management device according to claim 1 further comprising a controller configured to receive a signal representing the power status from the sensor.

3. A power management device according to claim 2, wherein the controller comprises:
a receiver configured to receive a signal from the sensor;
a microcontroller configured to receive the signal from the receiver; and
a relay controlled by the microcontroller.

4. A power management device according to claim 3, wherein the power distribution unit comprises:
a transformer;
one or more relays; and
one or more AC-DC converters connected with the transformer.

5. A power management device according to claim 2, wherein the sensor is configured to acquire the power status of the target system via a cable intervening into the target system.

6. A power management device in according to claim 5, wherein the controller is configured to command a PC subsystem to exit individual systems running thereon when the signal received by the controller represents that the target system has a power-off status.

7. A power management device according to claim 6, wherein the controller is configured to command the power distribution unit to power off all of the subsystems after having received the signal representing the power-off status for a period of time.

8. A power management device according to claim 7, wherein the controller is in communication with the PC subsystem via a RS232 standard interface.

9. An upgrade kit for upgrading a target system to a digital system, the upgrade kit comprising a power management device that comprises:
a sensor configured to sense a power status of the target system; and
a power distribution unit configured to power on or off all subsystems of the upgrade kit according to the power status.

10. An upgrade kit according to claim 9 further comprising a controller configured to receive a signal representing the power status from the sensor.

11. An upgrade kit according to claim 10, wherein the controller comprises:
a receiver configured to receive a signal from the sensor;
a microcontroller configured to receive the signal from the receiver; and
a relay controlled by the microcontroller.

12. An upgrade kit according to claim 11, wherein the power distribution unit comprises:
a transformer;
one or more relays; and
one or more AC-DC converters connected with the transformer.

13. An upgrade kit according to claim 10, wherein the sensor is configured to acquire the power status of the target system via a cable intervening into the target system.

14. An upgrade kit according to claim 13, wherein the controller is configured to command a PC subsystem to exit individual systems running thereon when the signal received by the controller represents that the target system has a power-off status.

15. An upgrade kit according to claim 14, wherein the controller is configured to command the power distribution unit to power off all of the subsystems after having received the signal representing the power-off status for a period of time.

16. An upgrade kit according to claim 15, wherein the controller is in communication with the PC subsystem via a RS232 standard interface.

17. An upgrade kit according to claim 11, wherein the sensor is configured to acquire the power status of the target system via a cable intervening into the target system.

18. An upgrade kit according to claim 12, wherein the sensor is configured to acquire the power status of the target system via a cable intervening into the target system.

19. A power management device according to claim 3, wherein the sensor is configured to acquire the power status of the target system via a cable intervening into the target system.

20. A power management device according to claim 4, wherein the sensor is configured to acquire the power status of the target system via a cable intervening into the target system.
